(19) United States
(12) Patent Application Publication
(10) Pub. No.: US 2016/0023881 A1
(43) Pub. Date: Jan. 28, 2016

(54) RECIRCULATING METHOD AND SYSTEM FOR BEVERAGE DISPENSER

(71) Applicant: Manitowoc Foodservice Companies, LLC, Manitowoc, WI (US)

(72) Inventors: Srikar Vemula, Jeffersonville, IN (US); Brian David Hornung, Salem, IN (US); Sam Jay Collier, New Albany, IN (US)

(21) Appl. No.: 14/338,444

(22) Filed: Jul. 23, 2014

(51) Int. Cl. B67D 1/08; B67D 3/00

(52) U.S. Cl. CPC B67D 1/0857; B67D 3/0009

(57) ABSTRACT

Disclosed are dispensing methods and systems for beverages that improve the quality (i.e., maintain desired temperature) of product dispensed by employing periodic recirculation of stagnant product, while reducing energy usage. The methods and systems use a recirculating pump associated with a first device that provides periodic power supply to the recirculation pump. The first device may comprise a device selected from a timer, a relay or a controller. The methods and systems may include a second device in association with the first device, and the second device senses a condition in the system and determines and measures a parameter of the condition. The second device signals the first device to periodically supply power to the recirculation pump based on the determined and measured parameter of the sensed condition. Preferably, the second device senses a parameter of pressure, temperature, electric current and/or voltage and product dispense-patterns.

### BACKGROUND

1. Field of the Disclosure

The present disclosure relates to methods and systems for dispensing beverages. More particularly, the present disclosure relates to methods and systems for dispensing beverages in which the dispensed plain/carbonated water and/or product are maintained at a more consistent dispensing temperature than in known methods and systems. The present disclosure achieves the more consistent dispensing temperature by intermittent recirculation of the plain/carbonated water and, optionally, product as will be more fully described herein.

2. Description of the Related Art

Currently, restaurants serve a variety of beverages such as carbonated and non-carbonated drinks. The state-of-the-art beverage systems/dispensers (“systems”) is such that such systems generally include a heat transfer system, a plumbing/manifold assembly, a valve/nozzle assembly and a carbonation system. The heat transfer system receives a supply of water and a supply of product (e.g., flavorings/syrups) that is cooled to a desired temperature. Some of the cooled water supply is transferred to the carbonation system where it is carbonated and thereafter returned to the heat transfer system for later transfer to the plumbing/manifold and valve/nozzle assembly for dispensing. Subsequently, chilled plain water, chilled carbonated water and chilled product are transferred from the heat transfer system to the plumbing/manifold assembly from which it/they is/are pumped to the valve/nozzle assembly and dispensed on demand to an end-user (restaurant employee and/or customer) through the valve/nozzle assembly.

Generally, the state-of-the-art systems are effective in maintaining the water/carbonated water/product within a reasonable dispensing temperature range. This is especially so when the beverage system/dispenser is under continuing regular use. However, when (as is common) there is a fluctuation in the consistency/time periods of use, the water/carbonated water/product may suffer from a wide variation in temperature ranges and, thus, the quality of the resulting product may be adversely affected.

For instance, the state-of-the-art systems provide an optimal and consistent beverage temperature performance in the range of 33° F.-40° F. during normal operation, but during periods of low/non-use the temperature performance is adversely affected due to the fact that chilled plain/carbonated water and product are not moved from the plumbing/manifold assembly to the valve nozzle assembly. This non-moving combination of ingredients (“stagnant” ingredients) results in a deteriorating temperature profile over a period of time (e.g., generally greater than or equal to about 30 min.). The dispensed beverages from the system after the low/non-use periods will have a decreased quality (temperature/consistency) of the beverage. This is due to an increase in temperature of the stagnant beverage in the plumbing/manifold and the valve/nozzle assemblies (i.e., greater than about 40° F.). Indeed, product suppliers often set maximum dispense temperatures for their product (i.e., 40° F.-42° F., or below, for example).

Attempts to avoid or overcome the increase in temperature of stagnant beverage in the plumbing/manifold and the valve/nozzle assemblies have been made. For instance, one method that has been used is chilling the area of the beverage system/dispenser in which the plumbing/manifold assembly and/or nozzle assembly is located. However, as can be appreciated, this can lead to significant unnecessary energy consumption, as well as increased manufacture costs. Alternatively, another method that has been used is continuous recirculation of the water/carbonated water from the plumbing/manifold assembly and/or nozzle assembly to the heat transfer system, and this method is commonly used in external chiller-based dispensing systems. However, these systems, likewise, consume a significant amount of energy due to the unnecessary (i.e., continuous) recirculation that recirculates product even when not necessarily needed.

Thus, a need exists for methods and systems that overcome the shortcomings caused by the state-of-the-art methods and systems for maintaining desired product temperature, such as chilling the entire area of the beverage system/dispenser in which the plumbing/manifold assembly and/or valve/nozzle assembly is located or, alternatively, utilizing continuous recirculation methods. The present disclosure provides methods and systems that overcome these shortcomings and satisfied those needs.

### SUMMARY OF THE DISCLOSURE

It is an object of the present disclosure to provide methods and systems that maintain desired product temperature without cooling entire areas or sections of the system.

It is also an object of the present disclosure to provide methods and systems that maintain desired product temperature without cooling by continuous recirculation.

It is a further object of the present disclosure to provide methods and systems that can be adjusted to meet the temperature requirements often set by product suppliers.

Is a still further object of the present disclosure to allow end users to set and regulate desired product temperature and automatically maintain a desired temperature.

It is an additional object of the present disclosure to allow end-users to set and regulate desired product temperature based on product-dispense parameters that are chosen by the end-users.

These and other objects of the present disclosure are met by the methods and systems disclosed herein that improve the quality (i.e., achieving constant target desired temperature) of the product that is dispensed after low/non-used times by intermittent recirculation of stagnant product that is in the plumbing/manifold and/or valve/nozzle assemblies. The methods and systems achieve this improvement by adding a timer/relay/controller to control activation and deactivation of the pump in the plumbing/manifold assembly. Preferably, the pump is either a pump with a backflow preventer/check valve and/or a unidirectional pump. The pump and backflow preventer/check valve, or unidirectional pump is, preferably, plumbed between the plumbing/manifold assembly and the heat transfer system. Contrary to the known methods and systems, the pump does not continuously recirculate beverage in the system. Rather, it employs one of the various methods and/or systems disclosed herein to intermittently recirculate beverage components, as required. The intermittent recirculation methods and systems maintain optimal and consistent temperatures of the dispensed product and reduce the energy usage of the pump.

Among the methods and systems for periodically recirculating product are time-based methods and systems, pressure change-based methods and systems, temperature change-based methods and systems, electric current and/or voltage-based methods and systems, dispense-pattern-based methods and systems and combinations of any of the foregoing. Of course, one skilled in the art will understand that other methods and systems for recirculation can be envisioned and utilized based on the many embodiments disclosed herein. According to preferred aspects of the present disclosure, it is only the chilled plain water/chilled carbonated water in the plumbing/manifold assembly that is recirculated to the heat transfer system. The reason for this is that a large percentage of the dispensed product resides in the plumbing/manifold assembly, with only a small percentage of the dispensed product residing at any time in the valve/nozzle assembly (e.g., in the ratio range of 80/90% product in the plumbing/manifold assembly to 10/20% product in the valve/nozzle assembly). Of course, if desired, it is possible based on the present disclosure to recirculate the dispensed product that is in the valve/nozzle assembly as well. Similarly, according to the present disclosure, it is only the chilled plain water and chilled carbonated water that are recirculated to the recirculation pump for transfer to the heat transfer system for cooling. The reason for this is, likewise, that chilled plain water and/or chilled carbonated water comprise a large percentage of the dispensed product that resides in the plumbing/manifold assembly. Of course, if desired, it is possible, based on the present disclosure, to recirculate the product (e.g., flavoring/syrup) as well.

One embodiment of the system of the present disclosure is a beverage dispensing system comprising a heat transfer system, a carbonation system, a plumbing/manifold assembly, a valve/nozzle assembly and a recirculation pump, wherein the recirculation pump is disposed between the plumbing/manifold assembly and the heat transfer system, wherein the recirculation pump is associated with a first device disposed between the recirculation pump and a power supply for the recirculation pump, and wherein the first device provides periodic power supply to the recirculation pump. Preferably, the first device comprises a device selected from a timer, a relay, a controller or any combinations of the foregoing.

Other embodiments of the system of the present disclosure further comprise a second device disposed in association with the first device, wherein the second device senses a condition in the system, wherein the second device determines a parameter of the condition, and wherein the second device signals the first device to periodically supply power to the recirculation pump based on the parameter of the sensed condition. Preferably, the second device is selected from a pressure sensing device, a temperature sensing device, a current and/or voltage sensing device, a dispense-pattern sensing device and any combinations of the foregoing. In a further embodiment of the system of the present disclosure, the second device is disposed in association with one or more of supply lines between the plumbing/manifold assembly and the valve/nozzle assembly that provide chilled plain water, chilled carbonated water and chilled product from the plumbing/manifold assembly to the valve/nozzle assembly, and the sensed condition is a condition in one or more of the supply lines. Preferably, in this embodiment the sensed condition is selected from the pressure, temperature, dispense-pattern and combinations of the foregoing in the one or more supply lines and any combinations of the foregoing.

Alternatively, the second device is disposed in association with a power supply for the valve/nozzle assembly and the sensed condition is a condition of electric current and/or voltage supplied to the valve/nozzle assembly. Preferably, the parameter of the sensed condition is the absence of change in the electric current and/or voltage provided to the valve/nozzle assembly, indicating that the valve/nozzle assembly has not been activated. In preferred embodiments of the system of the present disclosure, the recirculation pump is selected from a unidirectional pump and/or a pump in association with a backflow preventer. The unidirectional pump serves to prevent the flow of recirculating chilled plain water and/or chilled carbonated water from the recirculation pump to the plumbing/manifold assembly until desired by allowing pumped material to flow in only one direction without needing additional devices in association therewith. Likewise, the backflow preventer in association with the pump serves to prevent the flow of recirculating chilled plain water and/or chilled carbonated water from the recirculation pump to the plumbing/manifold assembly until desired.

Another embodiment of the present disclosure is a method of operating a beverage dispensing system comprising a heat transfer system, a carbonation system, a plumbing/manifold assembly, a valve/nozzle assembly and a recirculation pump, the method comprising disposing the recirculation pump between the plumbing/manifold assembly and the heat transfer system, associating the recirculation pump with a first device, disposing the first device between the recirculation pump and a power supply for the recirculation pump, controlling the power supply with the first device, and providing periodic power supply to the recirculation pump by the first device. Preferably, the first device comprises a device selected from a timer, a relay, a controller or any combinations of the foregoing.

Another embodiment of the method of the present disclosure further comprises providing a second device, disposing the second device in association with the first device, sensing a condition in the system by the second device, determining a parameter of the sensed condition by the second device, signaling the first device by the second device to supply power to the recirculation pump based on the determined parameter of the sensed condition, determining a change in the determined parameter of the sensed condition, and stopping the supply of power to the recirculation pump based on the change in the determined parameter of the sensed condition. Preferably, the second device is selected from a pressure sensing device, a temperature sensing device, a current and/or voltage sensing device, a dispense-pattern sensing device and any combinations of the foregoing. In yet another embodiment of the method of the present disclosure, the method further comprises disposing the second device in association with one or more of supply lines between the plumbing/manifold assembly and the valve/nozzle assembly that provide chilled plain water, chilled carbonated water and chilled product from the plumbing/manifold assembly to the valve/nozzle assembly and sensing a condition in one or more of the supply lines. Preferably, the sensed condition is selected from the pressure, temperature, dispense-pattern and any combinations of the foregoing in the one or more supply lines.

Alternatively, the method includes disposing the second device in association with a power supply for the valve/nozzle assembly and sensing a condition of electric current and/or voltage supplied to the valve/nozzle assembly. Preferably, the method additionally comprises sensing a parameter of the condition of electric current and/or voltage, wherein the parameter comprises an absence of change in the electric current and/or voltage, and activating the recirculation pump based on the absence of change in the electric current and/or voltage. In preferred embodiments of the system of the present disclosure, the recirculation pump is selected from a unidirectional pump and a pump in association with a backflow preventer. The unidirectional pump serves to prevent the flow of recirculating chilled plain water and/or chilled carbonated water from the recirculation pump to the plumbing/manifold assembly until desired by allowing pumped material to flow in only one direction without needing additional devices in association therewith. Likewise, the backflow preventer in association with a pump serves to prevent the flow of recirculating chilled plain water and/or chilled carbonated water from the recirculation pump to the plumbing/manifold assembly until desired.

### BRIEF DESCRIPTION OF THE DRAWINGS

The foregoing and other benefits of the beverage dispenser of the present disclosure will become further apparent to those skilled in the art from the detailed disclosure and the following Figures, in which:

FIG. 1 is a schematic diagram showing the components of a state-of-the-art beverage system/dispenser with a recirculation pump;

FIG. 2 is a schematic diagram showing the components of a beverage system/dispenser with a recirculation pump in one embodiment of the present disclosure employing a timer/relay/controller;

FIG. 3 is a schematic diagram showing the components of a beverage system/dispenser with a recirculation pump in a second embodiment of the present disclosure employing a timer/relay/controller in association with a pressure sensing device;

FIG. 4 is a schematic diagram showing the components of a beverage system/dispenser with a recirculation pump in a third embodiment of the present disclosure employing a timer/relay/controller in association with a temperature sensing device;

FIG. 5 is a schematic diagram showing the components of a beverage system/dispenser with a recirculation pump in a fourth embodiment of the present disclosure employing a timer/relay/controller in association with an electric current and/or voltage sensing device;

FIG. 6 is a schematic diagram showing the components of a beverage system/dispenser with a recirculation pump in a fifth embodiment of the present disclosure employing a timer/relay/controller i association with a dispense-pattern sensing device; and

FIG. 7 is a chart showing pump on/pump off times and resulting product temperatures using the methods and systems of the present disclosure.

### DESCRIPTION OF THE PREFERRED EMBODIMENTS

In the description of the Figures that follows, like elements will be denoted with like numerals throughout the Figures and description thereof.

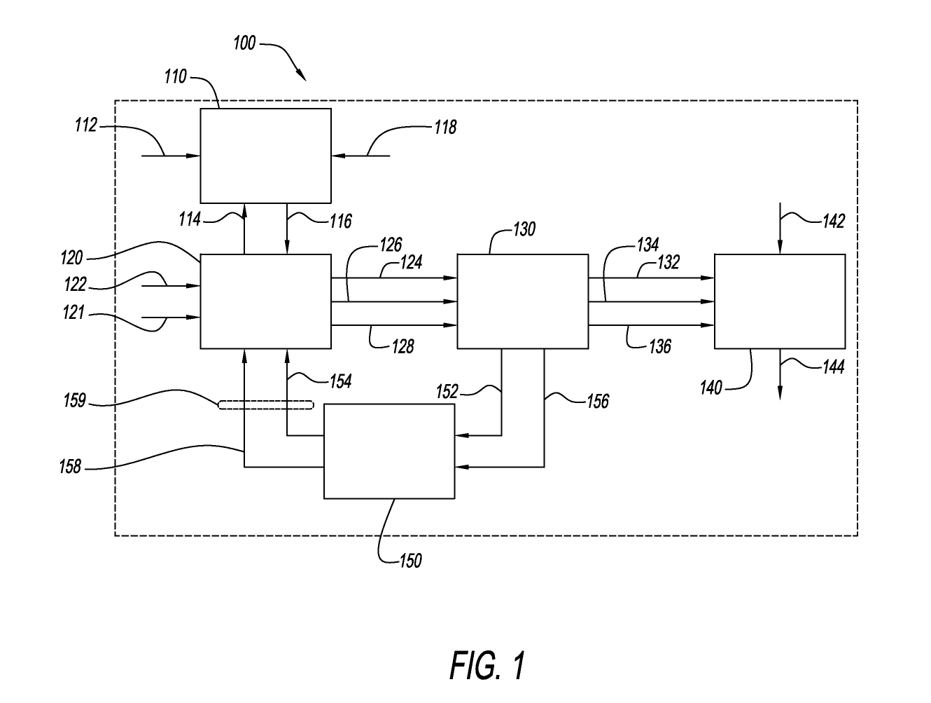

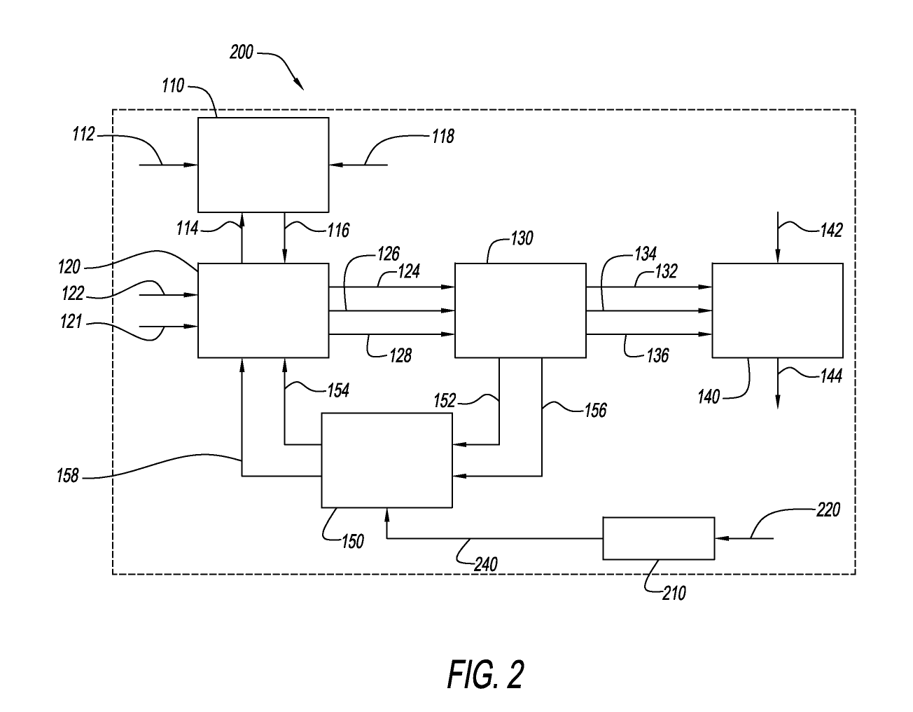

FIG. 1 show a state-of-the-art beverage system/dispenser (“system”). 100 that includes a carbonation system 110, a heat transfer system 120, a plumbing/manifold assembly 130, a valve/nozzle assembly 140 and a recirculation pump 150. Carbonation system 110 is provided with a supply of carbon dioxide through line 112 from a carbon dioxide source (not shown). Heat transfer system 120 is provided with a supply of product through a product supply line 121 and a supply of water through a water supply line 122 (both from sources not shown). Heat transfer system 120 chills the product supply and water supply and transfers pre-chilled water through a product transfer line 114 to carbonation system 110, where the pre-chilled water is carbonated. Thereafter, carbonated, pre-chilled water is transferred to heat transfer system 120 through a product transfer line 116. Carbonation system 110 is, generally, provided with a separate power supply 118. Heat transfer system 120 transfers chilled plain water, chilled carbonated water and chilled product to plumbing/manifold assembly through product lines 124, 126 and 128, respectively. Plumbing/manifold assembly 130 then transfers chilled plain water, chilled carbonated water and chilled product to valve/nozzle assembly 140 through product lines 132, 134 and 136, respectively. Valve/nozzle assembly 140 is, generally, provided with a separate power supply 142 that powers valve/nozzle assembly 140 to dispense chilled product through a product dispense line 144. In the state-of-the-art method and system, recirculation pump 150 continually recirculates chilled plain water through product lines 152 and 154 from plumbing/manifold assembly 130 to heat transfer system 120 and, likewise, continually recirculates chilled carbonated water through product lines 156 and 158 from plumbing/manifold assembly 130 to heat transfer system 120. From heat transfer system 120 chilled plain water, chilled carbonated water and chilled product are again transferred to plumbing/manifold assembly 130 through product lines 124, 126 and 128, respectively. Because recirculation pump 150 is continually recirculating chilled plain water and chilled carbonated water from plumbing/manifold assembly 130 to heat transfer system 120, recirculation pump 150 is powered from a source not shown in FIG. 1. In the embodiment of the present disclosure shown in FIG. 2, recirculation pump 150 is powered and thus activated for a certain predetermined duration of time. Recirculation pump 150 is also shown associated with a backflow preventer 159 (not shown again in FIGS. 2-6, but could be used in those situation where recirculation pump is not a unidirectional pump). The power source for recirculation pump 150 in the embodiment shown in FIG. 1 could be part of power supply 118 for carbonation system 110, part of power supply 142 for valve/nozzle assembly 140, or a separate power supply.

FIG. 2 shows a system 200, in which all of the components of system 200 are essentially the same as in system 100 in FIG. 1. In addition, FIG. 2 shows that system 200 includes a timer/relay/controller 210 that is connected to its own power supply 220. Timer/relay/controller 210 is also connected to recirculation pump 150 via power line 240. In the embodiment shown in FIG. 2, and different than the embodiment shown in FIG. 1, recirculation pump 150 is powered only by power supply 220 that is controlled by timer/relay/controller 210. Thus, power is supplied from power supply 220 via power line 240 to recirculation pump 150 according to the manner in which timer/relay/controller 210 is set. Recirculation pump 150 is turned off by timer/relay/controller 210 after completing one cycle of recirculation (i.e. activation time plus duration of time). Recirculation pump 150 repeats a cycle of recirculation based on turn on/turn off times and, thus, the recirculation cycle time, for each turn on/turn off determined by timer/relay/controller 210. According to this embodiment of the present disclosure, the duration of one cycle of recirculation may be randomly set by the end-user (i.e., the establishment in which system 200 is installed). In turn, one cycle of recirculation can be determined easily through trial and error by the end-user to attain, e.g., the desired product temperature, whether mandated by a product supplier or by the end-user. It will be appreciated by those skilled in the art that the duration of one cycle of recirculation may be adjusted according to parameters known to the end-user, such as time of day, outside temperature, and similar such parameters. The end-user would appreciate from experience that, for example, during peak use periods (such as lunch and/or dinner) one cycle of recirculation may occur less frequently (or not at all) than during non-peak use periods (such as mid-morning, mid-afternoon and/or late night).

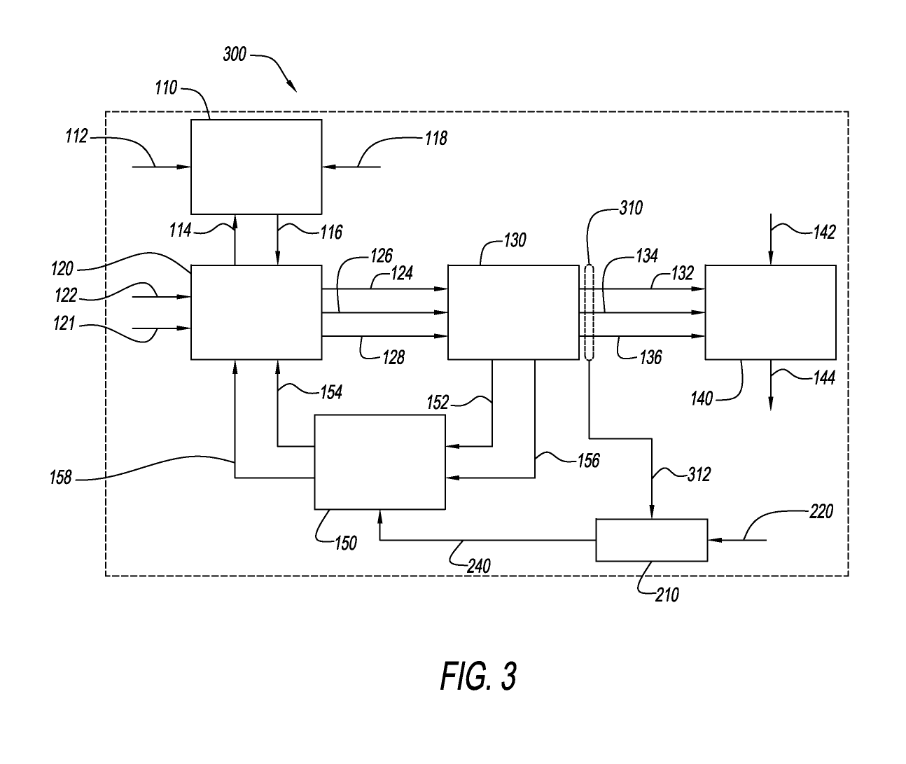

FIG. 3 shows a system 300, in which all of the components of system 300 are essentially the same as in system 200 in FIG. 2. System 300 is an embodiment of the present disclosure in which the activation and duration of timer/relay/controller 210 is not based upon a set time as is the case in the embodiment of FIG. 2. Rather, the activation and duration of timer/relay/controller 210 (and thus the activation/duration of recirculation pump 150) is based on monitoring pressure changes in plumbing/manifold assembly 130. As background, when a beverage is dispensed from valve/nozzle assembly 140 there is a pressure change (drop) in one or more of product lines 132, 134 and/or 136. According to the embodiment shown in FIG. 3, a change in pressure in one or more of product lines 132, 134 and/or 136 is detected by a pressure transducer/pressure switch 310 placed in association with plumbing/manifold assembly 130 which, in turn, is associated with timer/relay/controller 210 through a connection 312. If there is no pressure change detected (meaning no product is being/has been dispensed by valve/nozzle assembly 140) by pressure transducer/pressure switch 310 after a set duration of time (for example, approximately 8-12 min. at 90° F. ambient temperature and 65% relative humidity), pressure transducer/pressure switch 310 activates timer/relay/controller 210 through connection 312, and a recirculation cycle(s) of recirculation pump 150 will be performed, after which recirculation pump 150 will be turned off. Again, recirculation pump 150 continues to perform recirculation cycle(s) until such time as timer/relay/controller 210 is deactivated via connection 312 when pressure transducer/pressure switch 310 detects a pressure change in plumbing/manifold assembly 130. By performing pressure sensing using pressure transducer/pressure switch 310, timer/relay/controller 210 will be activated and deactivated by signals from connection 312. Therefore, in some respects, one skilled in the art can envision that system 300 automatically responds to peak use periods and non-peak use periods because pressure changes in plumbing/manifold assembly 130 are indicative of use, and lack of use, respectively. Alternatively, timer/relay/controller 210 may be activated if there is no change in pressure in plumbing/manifold assembly 130 over different preset time intervals. For example, timer/relay/controller 210 may be activated if there is no change in pressure in plumbing/manifold assembly 130 for 1, 5 or 10 min., or for any other time desired, and kept activated for any time period chosen by the end-user until such time as a change in pressure is detected.

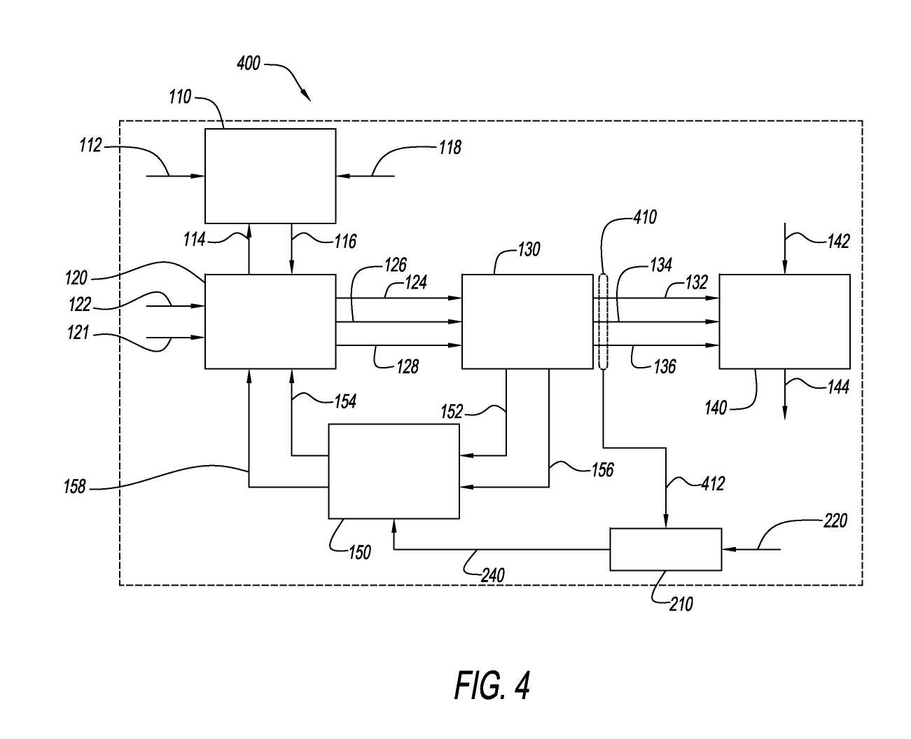

FIG. 4 shows a system 400, in which all of the components of system 400 are essentially the same as in system 300 in FIG. 3. System 400 is an embodiment of the present disclosure in which the activation and duration of timer/relay/controller 210 is not based upon a set time or pressure measurement. Rather, the activation and duration of timer/relay/controller 210 (and thus the activation/duration of recirculation pump 150) is based on monitoring temperature changes in plumbing/manifold assembly 130. As mentioned above, the quality of dispensed beverages from valve/nozzle assembly 140 depends on the temperature(s) in one or more of product lines 132, 134 and/or 136, usually of all three lines. According to the embodiment shown in FIG. 4, a change in temperature in one or more of product lines 132, 134 and/or 136 is detected by a temperature sensor 410 placed in association with plumbing/manifold assembly 130 which, in turn, is associated with timer/relay/controller 210 through a connection 412. If there is no temperature change detected (meaning that beverage quality is likely not affected) by temperature sensor 410 timer/relay/controller 210 is not activated through connection 412, and recirculation cycle(s) of recirculation pump 150 will not be performed. If, however, temperature sensor 410 detects an increase in temperature above a set threshold temperature (set, e.g., by the end-user or mandated by a product supplier), a signal will be sent to timer/relay/controller 210 via connection 412, timer/relay/controller 210 will be activated to start recirculation pump 150 to a perform recirculation cycle(s). Again, recirculation pump 150 continues to perform recirculation cycle(s) until such time as timer/relay/controller 210 is deactivated via connection 412 when temperature sensor 410 detects that a desired reduction to a predetermined lower temperature is attained in one or more of product lines 132, 134 and/or 136 of plumbing/manifold assembly 130. By temperature monitoring and sensing using temperature sensor 410, timer/relay/controller 210 will be activated and deactivated by signals from connection 412. Therefore, in some respects, one skilled in the art can envision that system 400 automatically responds to environmental (i.e., ambient temperature at a point of use location of system 400) because temperature changes in plumbing/manifold assembly 130 can be indicative of such ambient conditions. In the embodiment shown in FIG. 4, the temperature at which activation of timer/relay/controller 210 occurs and the temperature at which deactivation of timer/relay/controller 210 occurs can be selected according to particular needs. For example, the activation/deactivation temperature may be the same, e.g. 40° F., so that activation of timer/relay/controller 210 occurs when the measured temperature of plumbing/manifold assembly 130 goes above 40° F. and deactivation of timer/relay/controller 210 occurs when the measured temperature of plumbing/manifold assembly 130 reaches 40° F. More commonly however, the activation/deactivation temperature will be set as a range of temperatures, e.g. a 40° F. activation temperature and a 36° F. deactivation temperature. As will be apparent to those of skill in the art, use of temperature sensor 410 provides flexibility in the parameters used to attain satisfactory product quality.

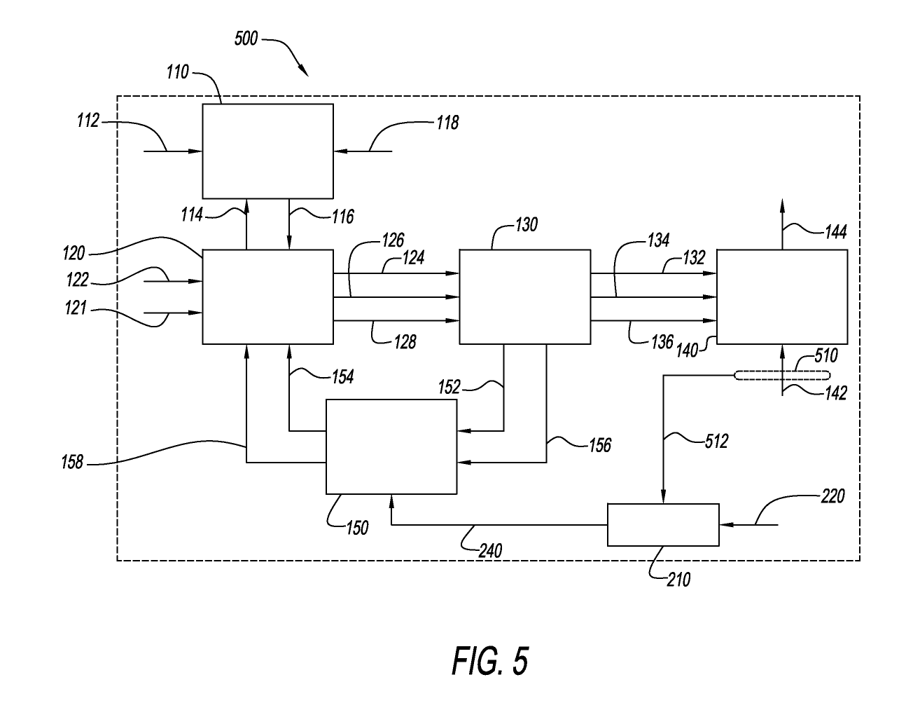

FIG. 5 shows a system 500, in which all of the components of system 500 are essentially the same as in systems 300 and 400 in FIGS. 3 and 4. System 500 is an embodiment of the present disclosure in which the activation/deactivation of timer/relay/controller 210 is not based upon a set time, pressure or temperature measurement. Rather, the activation/deactivation of timer/relay/controller 210 (and thus the activation/deactivation of recirculation pump 150) is based on changes in current and/or voltage supplied to and/or used by valve/nozzle assembly 140. In this situation, this embodiment of the present disclosure is similar in concept to that of FIG. 3 that measures pressure changes at one or more of product lines 132, 134 and/or 136, usually of all three lines of plumbing/manifold assembly 130. The pressure changes at one or more of product lines 132, 134 and/or 136 of plumbing/manifold assembly 130 indicate that valve/nozzle assembly 140 of system 300 is in use, and not requiring the recirculation provided by recirculation pump 150. Likewise, current and/or voltage use indicates that valve/nozzle assembly 140 of system 500 is in use, and not requiring the recirculation provided by recirculation pump 150. According to the embodiment shown in FIG. 5, a change in current and/or voltage use by valve/nozzle assembly 140 is detected by a current and/or voltage sensing device 510 placed in association with power supply 142 of valve/nozzle assembly 140. Current and/or voltage sensing device 510 is also associated with timer/relay/controller 210 through a connection 512. If there is no current and/or voltage change detected (meaning no product is being/has been dispensed by valve/nozzle assembly 140) by current and/or voltage sensing device 510 after a set duration of time (for example, approximately 8-12 min. at 90° F. ambient temperature and 65% relative humidity), current and/or voltage sensing device 510 activates timer/relay/controller 210 through connection 512, and a recirculation cycle(s) of recirculation pump 150 will be performed, after which recirculation pump 150 will be turned off. Again, recirculation pump 150 continues to perform recirculation cycle(s) until such time as timer/relay/controller 210 is deactivated via connection 512 when current and/or voltage sensing device 510 detects a current and/or voltage change at valve/nozzle assembly 140. By performing current and/or voltage change sensing using current and/or voltage sensing device 510, timer/relay/controller 210 will be activated and deactivated by signals from connection 512. Therefore, in some respects, one skilled in the art can envision that system 500 also can automatically respond to peak use periods and non-peak use periods because current and/or voltage changes at valve/nozzle assembly 140 are indicative of use, and lack of use, respectively. Alternatively, timer/relay/controller 210 may be activated if there is no change in pressure in plumbing/manifold assembly 130 over different preset time intervals. For example, timer/relay/controller 210 may be activated if there is no change in current and/or voltage pressure at valve/nozzle assembly 140 for 1, 5 or 10 min., or for any other time desired and kept activated for any time period chosen by the end-user until such time as a change in current and/or voltage is detected.

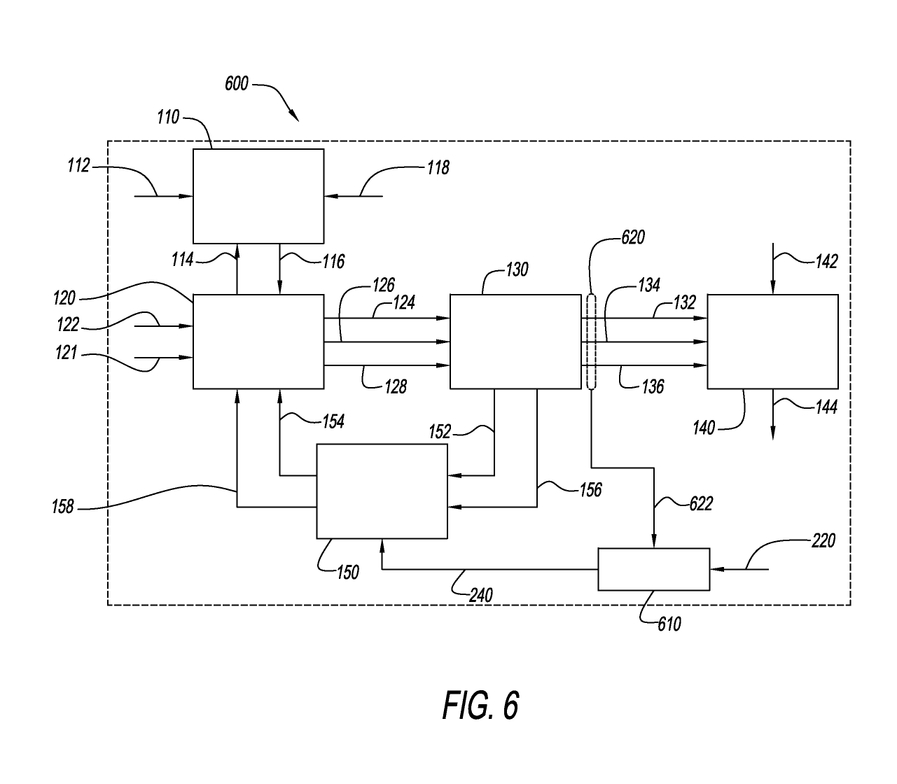

FIG. 6 shows a system 600, in which all of the components of system 600 are essentially the same as in systems 300, 400 and 500 in FIGS. 3, 4 and 5. System 600 is an embodiment of the present disclosure in which the activation/deactivation of a timer/relay/controller 610 is not based upon a set time, pressure, temperature or current and/or voltage measurement. Rather, the activation/deactivation of timer/relay/controller 610 (and thus the activation/duration of recirculation pump 150) is based on monitoring and recording dispense-patterns of either plumbing/manifold assembly 130 or valve/nozzle assembly 140. In the embodiment shown in FIG. 6, dispense-patterns of plumbing/manifold assembly 130 are monitored, but one skilled in the art would appreciate that dispense-patterns at valve/nozzle assembly 140 would be useful as well for the same purpose. In this embodiment of the present disclosure, system 600 is equipped with a self-learning timer/relay/controller 610 that records use, and therefore beverage dispense-patterns, at one or more of product lines 132, 134 and/or 136, usually of all three lines, of plumbing/manifold assembly 130. Self-learning timer/relay/controller 610 records the dispense-patterns over a course of time (e.g. a week), and also the dispense-patterns during each day of the week, as indicated by a dispense-pattern metering device 620 via a connection 622 with self-learning timer/relay/controller 610. Self-learning timer/relay/controller 610 thereafter is able to predict low/non-use periods during a week from that history. Self-learning timer/relay/controller 610 then activates recirculation pump 150 according to the dispense-patterns learned by self-learning timer/relay/controller 610. Again, self-learning timer/relay/controller 610 recognizes low/non-use periods and the duration of same. Therefore, self-learning timer/relay/controller 610 will maintain recirculation pump 150 activated for a time sufficient, and in accordance with, the recognized low/non-used periods and their duration. Therefore, one skilled in the art can envision that system 600 automatically responds to peak use periods and non-peak use periods as learned over a period of time. Likewise, the periods of peak use and non-peak use may change over longer periods of time (e.g., seasonally) and self-learning timer/relay/controller 610 will accommodate such seasonal changes.

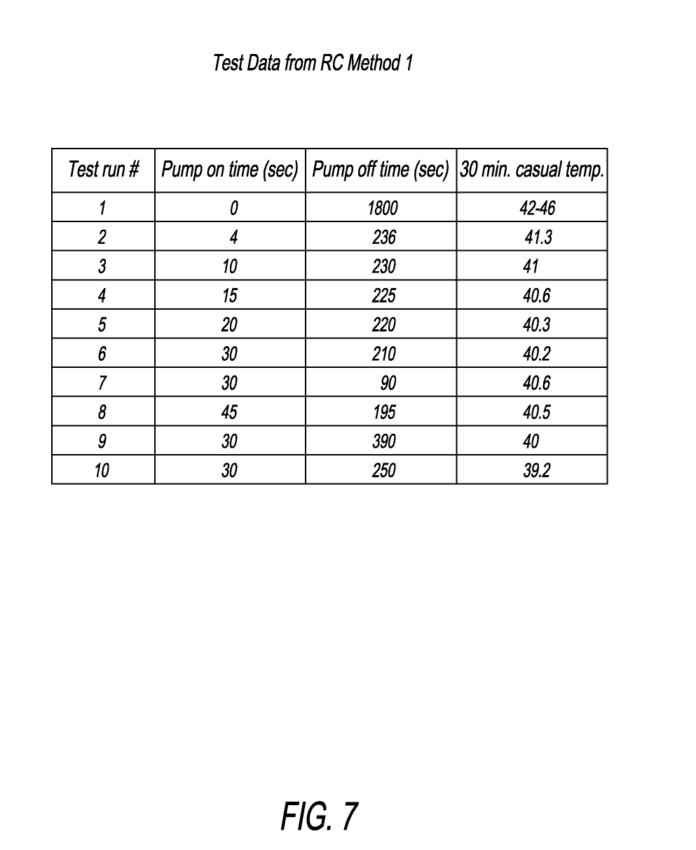

FIG. 7 shows resulting temperatures using various pump on/pump times according to the present disclosure. The target temperature of the embodiments shown in FIG. 7 was an assumed maximum target temperature of 42° F. In the table shown in FIG. 7, test run. #1 reflects the increase in temperature above the maximum often set by a product supplier without any recirculation via the recirculation pump over a period of time of 30 min. Test runs. #2-10 show that using various pump on, and pump off times the target maximum temperature of 42° F. can be attained using the intermittent recirculation systems and methods according to the present disclosure. More particularly, assuming a maximum product temperature, that is often set, by a product supplier of 41° F., test runs. #3-10 attain this target temperature. Further, assuming a maximum product temperature set by product supplier of 40° F., test runs. #9-10 attain this target temperature.

It should also be recognized that the terms “first”, “second”, “third”, “upper”, “lower”, and the like may be used herein to modify various elements. These modifiers do not imply a spatial, sequential, or hierarchical order to the modified elements unless specifically stated.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure not be limited to the particular embodiment(s) disclosed as the best mode contemplated, but that the disclosure will include all embodiments falling within the scope of the appended claims.

What is claimed is:

1. A beverage dispensing system comprising:
a heat transfer system;
a carbonation system;
a plumbing/manifold assembly;
a valve/nozzle assembly;
a recirculation pump disposed between the plumbing/manifold assembly and the heat transfer system; and
a plurality of supply lines interconnecting the foregoing systems and assemblies,
wherein the recirculation pump is associated with a first device disposed between the recirculation pump and a power supply for the recirculation pump, and
wherein the first device provides intermittent power supply to the recirculation pump to activate and deactivate the recirculation pump.

2. The beverage dispensing system according to claim 1, wherein the recirculation pump is selected from a unidirectional pump and/or a pump in association with a backflow preventer.

3. The beverage dispensing system according to claim 1, wherein the first device comprises a device selected from a timer, a relay, a controller or any combinations of the foregoing.

4. The beverage dispensing system according to claim 1, wherein the time for providing intermittent power to activate and deactivate the recirculation pump is based on a predetermined time interval.

5. The beverage dispensing device according to claim 4, wherein the predetermined time interval is between about 1-15 minutes.

6. The beverage dispensing device according to claim 4, wherein the predetermined time interval is between about 2-10 minutes.

7. The beverage dispensing device according to claim 4, wherein the predetermined time interval is between about 2-5 minutes.

8. The beverage dispensing system according to claim 1, further comprising:
a second device disposed in association with the first device,
wherein the second device senses a condition in the beverage dispensing system,
wherein the second device determines a parameter of the condition, and
wherein the second device signals the first device to provide intermittent power to the recirculation pump to activate and deactivate the recirculation pump based on the determined parameter of the sensed condition.

9. The beverage dispensing system according to claim 8, wherein the second device comprises a device selected from a pressure sensing device, a temperature sensing device, a current and/or voltage sensing device, a dispense-pattern sensing device and any combinations of the foregoing.

10. The beverage dispensing system according to claim 8, wherein the condition comprises pressure, voltage, current and any combinations of the foregoing, and wherein the parameter comprises an absence of change in the condition.

11. The beverage dispensing system according to claim 8, wherein the condition comprises temperature, and wherein the parameter comprises an increase in temperature above a predetermined temperature.

12. The beverage dispensing system according to claim 8, wherein the first device comprises a self-learning timer/relay/controller, wherein the second device comprises a dispense-pattern sensing device, wherein the condition comprises a dispense-pattern stored in the self-learning time/relay/controller, and wherein the parameter comprises a time-related use of the beverage dispensing system based on the stored dispense-pattern.

13. The beverage dispensing system according to claim 8, wherein the second device comprises a device selected from a pressure sensing device, a temperature sensing device, a dispense-pattern sensing device and any combinations of the foregoing disposed in association with one or more supply lines between the plumbing/manifold assembly and the valve/nozzle assembly.

14. A method of operating a beverage dispensing system comprising a heat transfer system, a carbonation system, a plumbing/manifold assembly, a valve/nozzle assembly and a recirculation pump, the method comprising:
disposing the recirculation pump between the plumbing/manifold assembly and the heat transfer system;
associating the recirculation pump with a first device;
disposing the first device between the recirculation pump and a power supply for the recirculation pump;
controlling the power supply for the recirculating pump with the first device; and
providing intermittent power supply to the recirculation pump by the first device.

15. The method of operating a beverage dispensing system according to claim 14, wherein the recirculation pump is selected from a unidirectional pump and a pump in association with a backflow preventer.

16. The method of operating a beverage dispensing system according to claim 14, wherein the first device comprises a device selected from a timer, a relay, a controller or any combinations of the foregoing.

17. The method of operating a beverage dispensing system according to claim 14, wherein the intermittent power to activate and deactivate the recirculation pump is based on a predetermined time interval.

18. The method of operating a beverage dispensing system beverage dispensing device according to claim 17, wherein the predetermined time interval is between about 1-15 minutes.

19. The method of operating a beverage dispensing system beverage dispensing device according to claim 17, wherein the predetermined time interval is between about 2-10 minutes.

20. The method of operating a beverage dispensing system beverage dispensing device according to claim 17, wherein the predetermined time interval is between about 2-5 minutes.

21. The method of operating a beverage dispensing system beverage dispensing device according to claim 14, further comprising:
disposing a second device in association with the first device,
sensing a condition in the system by the second device,
determining a parameter of the sensed condition by the second device,
signaling the first device by the second device to provide intermittent power to the recirculation pump to activate and deactivate the recirculation pump based on the determined parameter of the sensed condition.

22. The method of operating a beverage dispensing system beverage dispensing device according to claim 21, wherein the second device comprises a device selected from a pressure sensing device, a temperature sensing device, a current and/or voltage sensing device, a dispense-pattern sensing device and any combinations of the foregoing.

23. The method of operating a beverage dispensing system beverage dispensing device according to claim 21, wherein the condition comprises pressure, voltage, current and any combinations of the foregoing, and wherein the parameter comprises an absence of change in the condition.

24. The method of operating a beverage dispensing system beverage dispensing device according to claim 21, wherein the condition comprises temperature, and wherein the parameter comprises an increase in temperature above a predetermined temperature.

25. The method of operating a beverage dispensing system beverage dispensing device according to claim 21, wherein the first device comprises a self-learning timer/relay/controller, wherein the second device comprises a dispense-pattern sensing device, wherein the condition comprises a dispense-pattern stored in the self-learning time/relay/controller, and wherein the parameter comprises a time-related use of the beverage dispensing system based on the stored dispense-pattern.

26. The beverage dispensing system according to claim 21, wherein the second device comprises a device selected from a pressure sensing device, a temperature sensing device, a dispense-pattern sensing device and any combinations of the foregoing disposed in association with one or more supply lines between the plumbing/manifold assembly and the valve/nozzle assembly.
